(19) United States
(12) Patent Application Publication
(10) Pub. No.: US 2022/0411728 A1
(43) Pub. Date: Dec. 29, 2022

(54) HOME CARE PRODUCT OR FORMULATION

(71) Applicant: SYMRISE AG, Holzminden (DE)

(72) Inventors: Jörn WIEDEMANN, Holzminden (DE); Thorsten BÖDDEKER, Brakel (DE); Matthias WÜNSCH, Holzminden (DE)

(21) Appl. No.: 17/778,052

(22) PCT Filed: Nov. 19, 2019
(86) PCT No.: PCT/EP2019/081772

§ 371 Date: May 19, 2022

(51) Int. Cl. C11D 11/00; C11D 1/14; C11D 17/00; C11D 3/43; C11D 3/50

(52) U.S. Cl. CPC C11D 11/0058; C11D 1/146; C11D 17/0017; C11D 17/003; C11D 3/43; C11D 11/0023; C11D 3/50

(57) ABSTRACT

The present invention relates to a two component composition and a method for depositing a water-soluble film on a surface. The present two component composition comprises a first component comprising at least one, two, three or more or all first surfactants and water and a second component comprising at least one, two, three or more or all second surfactants and water, wherein contacting the first component a) and the second component b) causes forming of the water-soluble film. Also the present invention relates to a water-soluble film preferably a cleaning gel obtained or obtainable by a method according to the invention.

The present invention relates to a two component composition for depositing a water-soluble film on a surface. The water-soluble film thereby adheres on the surface, such as the inner surface of a toilet, providing a sustained release of an active ingredient depending from contacting/rinsing the film with water. The present invention further relates to a home care product comprising the two component composition, an easy method for depositing a water-soluble film on a surface and the use of the present two component composition or the present product. Also, the present invention relates to a water-soluble film, preferably a cleaning gel, obtained or obtainable by a method according to the invention.

Toilets require care to prevent the build up of unsightly deposits on the inner surface of the toilet, to reduce odours and to prevent growth of bacteria. Usually, toilets are cleaned, deodorized and disinfected by manual scrubbing with a liquid or powdered cleaning and sanitizing agent. This task requires regular manual labour to keep the toilet bowl clean.

Various automatic continuous toilet cleaning products have been proposed for eliminating repeated manual scrubbing. One type of product comprises a solid block or solid particles of a cleansing and freshening substance that is suspended from the rim of a toilet bowl in a container that is placed in the path of the flushing water. Typically, a portion of the solid block is dissolved in the flush water with each flush, and the flush water having dissolved product is dispensed into the toilet bowl for cleaning the bowl. These solid block toilet cleaning systems have certain disadvantages such as a short lifetime and a decline in the amount of cleaning and deodorizing agents released into the toilet bowl as the solid block deteriorates. Furthermore, such systems only have one particular aroma experience.

WO 2006/058894 A1 discloses an invisible toilet bowl deodoriser block. A holder for an active substance is proposed. The holder comprises an attachment portion for mechanical attachment at the edge of a toilet bowl, and a processor coupled to the mounting portion receiving section for an active substance. At least parts of the attachment portion are formed from a biodegradable material.

US 2004/221378 A1 discloses a device for dispensing liquids from under the rim of a toilet by way of the toilet flush water. The device includes a first arcuate bottle containing a first liquid and a second arcuate bottle containing a second liquid. The dispensing device has an arcuate base for holding the bottles. A wicking device supported by the base conveys liquid from the bottles to dispensing positions contacted with flush water. A hook is provided for suspending the base from a toilet rim.

AU 616193 B2 describes rigid gels, formed by anionic alkali metal C10-C16 alkyl ether sulfate surfactants (like SLES) in blends with ethoxylated fatty alcohols or fatty esters.

US 2014/0059752 A1 describes a monodose application tool which has been designed to stamp a gel formulation on a smooth surface. This device was later developed into a syringe, to enable more than one application (WO2019120931A1).

US 2019/174744 A1 describes a liquid formulation which is sprayed from a can and forms a gel after evaporation of the solvent. Compositions of synthetic clay and a cellulose derivative or of an organogel and a xerogel have been applied as gelling agent. Such sprayed gels have been especially fragranced to attract animals, e.g. ruminants.

U.S. Pat. No. 5,158,761 A describes spray base gels forming an aqueous carboxyvinyl polymer solution. With an appropriately adjusted viscosity, such thickened solutions show thixotropic behaviour, being liquid when sprayed and forming a gel when resting on a surface.

CA 1228293 A describes medicinal applications in which a solution of polyoxyethylene-polyoxybutylene copolymer has been sprayed onto tissues, where the aerosol turned into a gel.

U.S. Pat. No. 4,824,017 A describes spraying systems, comprising one solution of a resin and one solution of a catalyst, which are mixed externally to form especially stable gels, connecting the resins.

GB 2552864 A describes aerosols forming a gel, when sprayed onto a surface. The gelling behavior is based on a hydrophobically modified alkali-swellable acrylic emulsion (HASE) polymer in an amount of about 0.5 to about 3% polymer solids by weight of the composition. SLES in a concentration of up to 20% is only added to cause foaming.

The disadvantage of the above mentioned type of a conventional rim blocks resides in that no uniform fragrance distribution is obtained since it is attached to one position of the rim. Furthermore, this conventional rim block cannot be provided with a cleaning effect. A further disadvantage of conventional rim blocks is that it is only suitable for toilets with a rim. Hence, the customer must wait until the rim block is consumed before a new fragrance may be enjoyed. In addition, cleaning inside the rim is not possible. Furthermore, conventional rim blocks are usually available in rather bright colours, which some people do not like. Also, the market is saturated with traditional rim block forms. The customer rather wants an easy change of the rim block and easy switching to another fragrance. Some customers further do not like to see the physical presence of the rim block but still want to enjoy a fragrance effect.

Furthermore, the removal of a conventional rim block from the toilet is a hygienic issue and unpleasant to the consumer and to the environment (due to the related plastic waste). Even the gel syringe is not unproblematic to handle, as it contacts the toilet and has to be stored in the bathroom afterwards until its next usage.

The object of the present invention is to provide a means/device and method for cleaning a toilet bowl, such as via a rim block, which overcomes the above mentioned drawbacks of the prior art devices. A further objective resides in the provision of a means and method for cleaning a toilet bowl, wherein no attachment to a rim is required, such that the means may be easily applied to a toilet without rim. Another objective resides in the provision of a means and method that are advantageously applicable to all types of toilets. The means and method should furthermore provide easy application to the inner surface of a toilet. Advantageously, a combined fragrance effect and cleaning effect should be possible.

These objectives are achieved by the two component composition according to the invention, the present home care product, the present method for depositing a water-soluble film on a surface and the use of the present two component composition or home care product as/in a surface cleaning product.

Therefore, a two component composition is provided which is advantageously liquid and may therefore be applied by e.g. spraying to deposit a water-soluble film on a surface.

The two component composition for depositing a water-soluble film on a surface comprises or consists of:
a) a first component a) comprising or consisting of
   a1) 0 to 30 wt.-%, preferably 7 to 27 wt.-%, particularly preferably 15 to 25 wt.-% of one, two, three or more first surfactants, based on the total weight of the first component a),
   a2) 60 to 100 wt.-%, preferably 65 to 90 wt.-%, particularly preferably 70 to 80 wt.-% of water, based on the total weight of the first component a), and
   a3) 0 to 10 wt.-%, preferably 2 to 5 wt.-% of one, two, three or more first active substances, based on the total weight of the first component a), and
b) a second component b) comprising or consisting of
   b1) 40 to 80 wt.-%, preferably 45 to 70 wt.-%, particularly preferably 50 to 60 wt.-% of one, two, three or more second surfactants, based on the total weight of the second component b),
   b2) 0 to 40 wt.-%, preferably 5 to 35 wt.-%, particularly preferably 10 to 30 wt.-%, especially preferably 20 to 25 wt.-% of water, based on the total weight of the second component b),
   b3) 0 to 10 wt.-%, preferably 2 to 5 wt.-% of one, two, three or more second active substances, based on the total weight of the second component b),
   and
   b4) 15.5 to 35 wt.-%, preferably 16 to 25 wt.-%, particularly preferably 17 to 22 wt.-% of one, two, three or more solvents, based on the total weight of the second component b),

wherein contacting the first component a) and the second component b) causes forming of the water-soluble film.

The term “comprising 0 to 30 wt.-%” of a component as is used herein is meant to be understood such that said component may either be not present (i.e. 0 wt.-%) or be present, wherein, if present, said component is present in an amount of up to 30 wt.-%. The same applies accordingly to the term “comprising 0 to 10 wt.-%” of a component, the term “comprising 0 to 20 wt.-%” of a component, and the like. Preferably, if present, said component is present in an amount of at least 0.5 wt.-%, preferably 1 wt.-%, 1.5 wt.-%, 2 wt.-%, 2.5 wt.-%, 3 wt.-%, 3.5 wt.-%, 4 wt.-%, 4.5 wt.-%, 5 wt.-%, wherein at the same time, the amount of said component does not exceed the indicated maximum weight percentage, e.g. 10 wt.-%, 20 wt.-% or 30 wt.-%.

It will be readily understood that in a two component composition, each component remains as individual (or isolated) entity. Contacting/mixing of the two components usually takes place upon using the two component composition for (preparing and) depositing a water-soluble film on a surface.

For providing a water-soluble film which also adheres to the surface and resists being immediately washed away by rinsing water, several concentrations of the components have been tested. A higher viscosity causes a higher resistance of the film against the rinsing water. However, as the film needs to be applied, advantageously sprayed, on a surface, the mixture needs to have a rather low viscosity. Spraying a mixture with high viscosity (and thus an assumed higher resistance) led to heavy foaming of the mixture or clogging of the nozzle and the film was immediately washed away. However, spraying a mixture with a particularly low viscosity led to a low resistance of the film, which was also immediately washed away. These experiments thus underline the necessity of a two component composition.

Additionally, a method for depositing a water-soluble film on a surface is provided. The method comprises:
i) providing a first component comprising or consisting of
   a1) 0 to 30 wt.-%, preferably 7 to 27 wt.-%, particularly preferably 15 to 25 wt.-% of one, two, three or more first surfactants, based on the total weight of the first component a),
   a2) 60 to 100 wt.-%, preferably 65 to 90 wt.-%, particularly preferably 70 to 80 wt.-% of water, based on the total weight of the first component a),
   and
   a3) 0 to 10 wt.-%, preferably 2 to 5 wt.-% of one, two, three or more first active substances, based on the total weight of the first component a),
ii) providing a second component comprising or consisting of
   b1) 40 to 80 wt.-%, preferably 45 to 70 wt.-%, particularly preferably 50 to 60 wt.-% of one, two, three or more second surfactants, based on the total weight of the second component b),
   b2) 0 to 40 wt.-%, preferably 5 to 35 wt.-%, particularly preferably 10 to 30 wt.-%, especially preferably 20 to 25 wt.-% of water, based on the total weight of the second component b),
   b3) 0 to 10 wt.-%, preferably 2 to 5 wt.-% of one, two, three or more second active substances, based on the total weight of the second component b),
   and
   b4) 15.5 to 35 wt.-%, preferably 16 to 25 wt.-%, particularly preferably 17 to 22 wt.-% of one, two, three or more solvents, based on the total weight of the second component b),
iii) contacting the first component and the second component for obtaining a mixture, and
iv) depositing the mixture on a surface,

wherein contacting the first component a) and the second component b) causes forming of the water-soluble film, preferably a hydrogel.

The method according to the invention is preferably performed under standard conditions, i.e. a pressure of 1013 mbar and a temperature of 20° C.

The invention further relates to a water-soluble film, preferably as described herein, particularly preferably a (toilet) cleaning gel, obtained or obtainable by a method as described herein.

The term “gel” as in (toilet) cleaning gel is preferably used for describing a mass which may stick to a surface and which is preferably formed by molecular self-assembly instead of initially providing macromolecules.

What is said herein with regard to either of the present two component composition, the present method for depositing a water-soluble film on a surface or the present water-soluble film obtained or obtainable by a method as described herein also applies to the other ones accordingly, where applicable.

The present two component composition and present method for depositing a water-soluble film on a surface and the present water-soluble film obtained or obtainable by a method as described herein offers the advantage that no attachment to a rim is required. Hence, the present invention may be easily applied to toilets without rim. The present two component composition and present method provide easy application to the inner surface of a toilet. In comparison to a conventional rim block, a higher surface area may be provided with active constituent release, such as fragrance release and blooming. A further advantage resides in that the two component composition can be provided with several effects at the same time, such as a combined fragrance effect and cleaning effect. Furthermore, the two component composition may be essentially provided with each colour, such as a transparent colour, which does not attract attention, or with any colour, the intensity of which may be used as an indicator for surface thickness of the film and in consequence about the endurance of the active ingredient effect. The present two component composition is furthermore suitable for conventional and modern toilets. In both cases cleaning inside the rim is possible at any time. In addition, the customer can enjoy multiple fragrances depending upon the surface area they spray the present two component composition. This provides flexibility to enjoy high fragrance performance. The size of the surface area provided with the present film and/or its thickness permits adjusting the lifetime of the active ingredient effect. For instance, in case a (toilet) cleaning gel is provided, the active ingredient effect may last for e.g. 5 to 20 flushes.

Furthermore, the composition may be applied by spraying with e.g. a can. Depending on the size of the can, the amount of contained first or second components may be sufficient for a high number of applications and one filling of the cans thus typically results in a longer time of use than a single regular rim block. Additionally, the can may advantageously be refillable and can be cleaned to be used for the same or other purposes. Thus, the amount of plastic waste is critically reduced compared to regular rim blocks usually contained in a plastic basket.

It is preferred in connection with the present two component composition and present method for depositing a water-soluble film that the first component a) and the second component b) are present in liquid form (when they are present as separated components). Additionally, or alternatively, the first component a) and the second component b) together form a hydrogel when contacted with each other. The two components a) and b) being liquid has the additional advantage that a conventional applicator, preferably a spraying device or a broad mouth plastic applicator, may be used for applying the first component a) and the second component b) on a surface individually or combined. Hence, the present invention may also encompass a system, wherein the system comprises an applicator, preferably an application device, in addition to the present two component composition. It will be appreciated that the system may comprise further entities, such as a first compartment for storing the first component a) and a second compartment for storing the second component b), preferably wherein the first compartment and the second compartment are both housed in a housing, such that easy handling, in particular one-handed operation, of the system by the customer is rendered possible.

It will be furthermore appreciated that the present two component composition may comprise one or more additional components, such as a third component or a third and fourth component, c) or, respectively, d). For instance, the third component c) may have the same constituents like the first component and/or the second component with the proviso of including another active constituent, such as another fragrance(s) (than already comprised in the first compartment or second compartment). In this case, a system may be provided having in addition a third compartment for storing the third component, (and optionally any number of further compartments for storing further components). In this case the applicator, preferably the spraying device, provides the customer selectively combining the contents of two (of the three, four, etc.) compartments, such that in each case the application of one, two, three or more or all first surfactants and one, two, three or more or all second surfactants as well as water is rendered possible.

A “water-soluble film” as used herein designates a film which on the one hand solidifies and fixedly adheres to a surface, such as a metal, plastic, glass or ceramic surface, preferably a ceramic surface of a toilet. Preferably, the solidification of the film occurs by forming a (water-soluble) hydrogel. Contacting the water-soluble film, which has been deposited on the surface and which adheres thereto, with water has the effect that the water-soluble film is dissolved over a period of time, such as 1 day or more, 2 days or more, 3 days or more, 4 days or more, 5 days or more, 6 days or more, 1 week or more, or 2 weeks or more, inter alia depending upon thickness of product layer applied. In other words, the water-soluble film is only removed to a small extend from the surface upon a single contact with water. Such a single contacting with water may include single flushing of a toilet or single operating the tap of sink for a limited time, such as the time required for washing hands. The present water-soluble film completely dissolves, and in consequence is completely removed from the surface, after multiple single contacting with water, e.g. 10 times or more (i.e. corresponding to 10 times operating a toilet rinse or 10 times operating a water tap for washing hands), preferably 20 times or more or 30 times or more.

Additionally, or alternatively, the effect that the water-soluble film is dissolved over a prolonged period of time and a complete dissolution is not observed already with the first contact of e.g. flush water or tap water, is preferably influenced by the viscosity of the water-soluble film, particularly preferably by the viscosity of the hydrogel formed when the first component a) and the second component b) are contacted with each other. Therefore, it is preferred that the water-soluble film, particularly preferably the hydrogel, formed when the first component a) and the second component b) are contacted with each other has a viscosity of at least 300 mPa*s (\dot{y}=10 ms⁻¹, τ=6.4 Pa), preferably of at least 1000 mPa*s, particularly preferably of at least 26000 mPa*s.

Furthermore, it has been surprisingly found that certain concentrations and/or ratios of surfactant(s), water and optionally solvent(s) or active substance(s) in the film, which is formed by addition of the first component a) and the second component b), provide a particularly high viscosity which is particularly advantageous for prolonging the time to complete dissolution of the film. Therefore, it is preferred that the first and second components together comprise 25 to 50 wt.-%, preferably 30 to 45 wt.-% of surfactant(s), based on the total weight of the first and second components together. Additionally, or alternatively, it is preferred that the first and second components together comprise 30 to 65 wt.-%, preferably 40 to 60 wt.-% of water, based on the total weight of the first and second components together. Additionally, or alternatively, it is preferred that the first and second components together comprise 0 to 20 wt.-%, preferably 3 to 20 wt.-%, preferably 7.5 to 15 wt.-%, particularly preferably 6.5 to 14 wt.-% of solvent(s), based on the total weight of the first and second components together. Additionally, or alternatively, it is preferred that the first and second components together comprise 0 to 10 wt.-%, preferably 1.5 to 5 wt.-% of active substance(s), based on the total weight of the first and second components together. It is especially preferred that the first and second components together comprise 25 to 50 wt.-%, preferably 30 to 45 wt.-% of surfactant(s), 30 to 65 wt.-%, preferably 40 to 60 wt.-% of water, 0 to 20 wt.-%, preferably 6.5 to 14 wt.-% of solvent(s) and 0 to 10 wt.-%, preferably 1.5 to 5 wt.-% of active substance(s), each based on the total weight of the first and second components together.

The properties of the water-soluble film render it particularly suitable for use as a (toilet) cleaning gel. The use of the water-soluble film is, however, not restricted to an inner surface of a toilet. Rather each surface which is subjected to a temporary or a continuous contact with an aqueous solution, preferably water as such or water having a minor amount of other constituents, such as 5 wt.-% or less, may be contacted with the present two component composition.

Surfactants are amphiphilic substances. The hydrophilic proportions of a surfactant molecule are usually polar functional groups, e.g. —COO⁻, —OSO₃⁻, and —SO₃⁻, PEG, sugar derivatives or OPO₃²⁻, whereas the hydrophobic proportions are usually nonpolar carbohydrate rests. Surfactants are generally classified according to class and charge of the hydrophilic molecule proportion. Hereby four groups can be distinguished; anionic surfactants, cationic surfactants, amphoteric surfactants and non-ionic surfactants.

It is preferred that the, one, two, three or more or all of the first surfactant(s) a1) and/or the, one, two, three or more or all of the second surfactant(s) b1) is/are selected from the group consisting of anionic surfactants, cationic surfactants, amphoteric surfactants and non-ionic surfactants.

Anionic surfactants usually share as functional groups carboxylate, sulphate or sulphonate or phosphorous (e.g. lecithins) groups. In aqueous solution they form negatively charged organic ions in the acidic or neutral milieu. Cationic surfactants are almost exclusively classified by the presence of a quaternary ammonium group. In aqueous solution they form positively charged organic ions in the acidic or neutral milieu. Amphoteric surfactants contain both, anionic and cationic groups and thus behave in aqueous solution as anionic or cationic surfactants, depending on the pH. In the strongly acidic milieu they are positively charged, whereas in the alkaline milieu they are negatively charged. In the neutral pH range however, they are zwitterionic. Typical for non-ionic surfactants are polyether chains. Non-ionic surfactants do not form ions in aqueous medium.

Advantageously used anionic surfactants are acylamino acids (and their salts), such as acyl glutamates e.g. sodium acyl glutamate, Di-TEA-palmitoyl-aspartate and sodium capryl/capringlutamate; acyl peptides such as palmitoyl-hydrolyzed milk protein, sodium cocoyl-hydrolyzed soy protein and sodium/potassium cocoyl-hydrolyzed collagen; sarcosinates such as myristoyl sarcosin, TEA-lauroylsarcosinate, sodium lauorylsarcosinate and sodium cocoylsarcosinate; taurates such as sodium lauroyltaurate and sodium methylcocoyltaurate; acyllactylates, lauroyllactylate, caproyllactylate; alaninate, carboxylic acids and derivatives such as lauric acid, aluminium stearate, magnesium alkanolate, zinc undecylenate; ester carboxylic acids such as calcium stearoyllactylate, laureth-6 citrate and sodium PEG-4 lauramidcarboxylate; ether carboxylic acids such as sodium laureth-13 carboxylate and sodium PEG-6 cocamide carboxylate; phosphoric acid esters and salts such as DEA-oleth-10-phosphate and dilaureth-4 phosphate; sulphonic acids and salts such as acyl-isothionates, e.g. sodium/ammonium cocoyl-isethionate; alkylarylsulphonates; alkylsulphonates such as sodium cocosmonoglyceridsulphate, sodium C12-14 olefinsulphonate, sodium laurylsulphoacetate and magnesium PEG-3 cocamidsulphate; sulphosuccinate such as dioctylsodium sulphosuccinat, disodium laurethsulphosuccinat, disodium laurylsulphosuccinate and disodium undecylenamido MEA-sulphosuccinate; as well as sulphuric acid esters such as alkylethersulphate e.g. sodium, ammonium, magnesium, MIPA, TIPA laurethsulphate, sodium myrethsulphate and sodium C12-113 parethsulphate; alkylsulphates, e.g. sodium, ammonium and TEA-laurylsulphate, individually or in combinations. Hansanol NS 242 of the Hansa Group AG is a preferred anionic surfactant as well as Zetesol NL-2 and Sodium Laureth sulfate.

Advantageously used cationic surfactants are alkylamines, alkylimidazoles, ethoxylated amines and quarternatry surfactants, such as esterquats.

Esterquats generally base on quarternary triethanol-methy-ammonium or quarternary diethanol-dimethyl-ammonium compounds. The required, long carbohydrate chains are attached as fatty acid esters individually or in combinations. These are easily separated during the biological degradation, which is very advantageous for the degradation at least as a first step. Preferred esterquats comprise for example Rewoquat WE 18 (Evonic Goldschmidt GmbH). Esterquats can also serve as plasticizers.

Quarternary surfactants contain at least one N-atom, which is covalently bound to 4 alkyl or aryl groups. This results, independent of the pH value, in a positive charge. Advantageous are alkylbetaine, alkylamidopropylbetaine and alkylamidopropylhydroxy-sulphaine.

The used cationic surfactants can further be chosen preferably of the group of quarternary ammonium compounds, particularly benzyltrialkylammonium chlorides or bromides, such as benzyldimethylstearyl-ammonium chloride, further alkyltrialkylammonium salts, such as cetyltrimethylammonium chloride (cetrimonium chloride) or bromide, alkyldimethylhydroxyethylammonium chloride or bromide, dialkyldimethylammonium chloride or bromide, alkylamidethyltrimethyl-ammonium ether sulphates, alkylpyridinium salts such as lauryl or cetylpyrimidinium chloride, imidazolin derivatives and compounds with cationic character such as aminoxides individually or in combinations, e.g. alkyldimethylamin oxides or alkylaminoethyldimethylamin oxides. Cetyltrimethylammonium salts are particularly preferred.

Advantageously used amphoteric surfactants are Acyl-/dialkylethylendiamine, such as sodium acylamphoatetate, disodium acylamphodipropionate, disodium alkylamphodiacetate, sodium acylamphohydroxy-propylsulphonate, disodium acylamphodiacetate and sodium acylamphopropionate; N-alkyl amino acids such as aminopropylalkyl glutamide, alkylamino propionic acid, sodium alkyliminodipropionate and lauroamphocarboxy glycinate individually or in combinations.

Advantageously used non-ionic surfactants are Alkohols; Alkanolamides such as Cocamide MEA/DEA/MIPA; Aminoxides such as Cocoamidopropylaminoxide; esters, which arise by esterification of carboxylic acids with Ethylenoxide, Glycerin, Sorbitan or other alcohols; Ethers such as ethoxylated/propoxylated alcohols, ethoxylated/propoxylated esters, ethoxylated/propoxylated glycerine esters, ethoxylated/propoxylated cholesterins, ethoxylated/propoxylated triglyceride esters, ethoxylated/propoxylated lanolin, ethoxylated/propoxylated polysiloxanes, propoxylated POE-ethers and alkylpolyglycosides such as laurylglucoside, decylglycoside and cocoglycoside; sucrose esters; ether; polyglycerine esters such as diglycerine esters, monoglycerin esters; methylglucose esters; esters of hydroxyl acids individually or in combinations.

The use of a combination of one, two, three, four or more anionic and/or amphoteric surfactants with one or more non-ionic surfactants is further advantageous.

Further suitable surfactants can be found in e.g. US 2016/304813 A1, DE 102013205092 A1, DE 102012203989 A1, DE 102012203986 A1, DE 19919088 A1 and DE 10019142 A1, the contents of which are incorporated by way of reference.

According to own experiments, the surfactants cetrimonium chloride and Sodium Laureth sulfate showed particularly advantageous results and were thus even more advantageous than the other surfactants.

It is further preferred that a hydrogel, preferably a water soluble hydrogel, is formed when the first component a) and the second component b) are contacted with each other. Particularly preferably, the, one, two, three or more or all of the first surfactant(s) a1) correspond to the, one, two, three or more or all of the second surfactant(s) b1). This is to be understood such that either all of the surfactants of a1) correspond to all the surfactants b1) or that only selected surfactants of a1) or b1) correspond to all of or selected surfactants of b1) or a1).

The term “the, one, two, three or more or all substances of one component correspond to the, one, two, three or more or all substances of another component” is meant to be understood such that the components contain either the same number of different substances or a different number of different substances, wherein in both cases the indicated number of substances, preferably at least the indicated number of substances, correspond to each other.

It is preferred that the, one, two, three or more or all of the solvent(s) b4) is/are selected from the group consisting of lower alcohols (such as methanol, ethanol and propanol), tripropylene glycol methyl ether (TPM), dipropylene glycol methyl ether (DPM), 3-methoxy-3-methyl-1-butanol (MMB), DMSO, glycerine, triacetin, ethylene glycol, glycol, propanediol, augeo, trimethyleneglycol, methyl ethyleneglycol, ethyl ethylenglycol, methyl propylenglycol, ethyl aceto acetate, ethyl acetate, DPG, DPMA, Cellulose acetate and ACN.

Typically, the solvent(s) b4 is/are selected such that the surfactant(s) b1 and optionally a1 is/are soluble in the selected solvent(s) b4.

The term “active substance”, i.e. components a3) or b3), as used herein broadly pertains to compounds including active constituents, such as a fragrance (as understood by a person skilled in the art), co-solvents, preservatives, abrasives, anti-irritants, irritation suppressants, antimicrobial compounds, antioxidants, antiseptics, binders, buffers, chelating agents, deodorisers, disintegrants, emollients, fixatives, foaming agents, foam stabilisers, antifoams, foam boosters, fungicides, humectants, moisturisers, bleaching agents, stain removers, insect repellents, opacifiers, plasticisers, brighteners, abrasive agents, skin care agents, skin-protecting agents, skin-softening agents, skin-cooling agents, skin-warming agents, stabilisers, UV-absorbers, thickeners, vitamins, oils, waxes, fats, phospholipids, mono- or polyunsaturated fatty acids, α-hydroxy acids, polyhydroxy fatty acids, dyes, colour-protection agents, pigments, plant extracts, electrolytes, or silicone derivatives. The skilled person is well aware about employing one or more of said constituents in the required amount(s) and/or the required use, such as the formulation of a home care product or a (toilet) cleaning gel. Examples of preferred excipients, which may be used in the present two component composition encompass non-ionic surfactants, anionic surfactants, such as sodium laureth sulfate, an emulsifier, such as a PEG and glycerine, a carrier material, such as mineral oil or a starch, preferably starch paste, and a dye, such as brilliant blue FCF and tartrazine, individually or in combinations.

Preferably the, one, two, three or more or all of the first active substance(s) a3) and/or the, one, two, three or more or all of the second active substance(s) b3) is/are (a) fragrance(s) selected from the group consisting of
linalool, coumarin, geraniol, eugenol, limonene, and citral, and/or
cyclic terpene alcohols such as for example: menthol; isopulegol; alpha-terpineol; terpinenol-4; menthan-8-ol; menthan-1-ol; menthan-7-ol; borneol; isoborneol; linalool oxide; nopol; cedrol; ambrinol; vetiverol; guaiol; and the formates, acetates, propionates, isobutyrates, butyrates, isovalerates, pentanoates, hexanoates, crotonates, tiglinates and 3-methyl-2-butenoates, 1,4-octanolide; 3-methyl-1,4-octanolide; 1,4 nonanolide; 1,4-decanolide; 8-decen-1,4-olide; 1,4-undecanolide; 1,4-dodecan-olide; 1,5-decanolide; 1,5-dodecanolide; 4-methyl-1,4-decanolide; 1,15-penta-decanolide; cis- and trans-11-pentadecen-1, 15-olide; cis- and trans-12-pentadecen-1,15-olide; 1,16-hexadecanolide; 9-hexadecen-1,16-olide; 10-oxa-1,16-hexadecanolide; 11-oxa-1,16-hexadecanolide; 12-oxa-1,16-hexadecanolide; ethylene 1,12-dodecanedioate; ethylene 1,13-tridecanedioate; coumarin; 2,3 dihydrocoumarin; octahydrocoumarin, citronellol; geraniol; nerol; linalool; lavandulol; nerolidol; farnesol; tetrahydrolinalool; tetrahydrogeraniol; 2,6-dimethyl-7-octen-2-ol; 2,6-dimethyloctan-2-ol; 2-methyl-6-methylene-7-octen-2-ol; 2,6-dimethyl-5,7-octadien-2-ol; 2,6-dimethyl-3,5-octadien-2-ol; 3,7-dimethyl-4,6-octadien-3-ol; 3,7-dimethyl-1,5,7-octatrien-3-ol; 2,6-dimethyl-2,5,7-octatrien-1-ol; and the formates, acetates, propionates, isobutyrates, butyrates, isovalerates, pentanoates, hexanoates, crotonates, tiglinates and 3-methyl-2-butenoates, and/or
(customary product and brand names are given): 1-phenyl-2-methyl-2-propylacetate, 2-methylbutylbutyrate, aldron (4-[(3,3-dimethylbicyclo[2.2.1]hept-2-yl)methyl]-2-methylcyclohexanon), allyl-2-cyclohexyloxyglycolate, allyl-2-pentyloxyglycolate, allyl-3-cyclohexylpropionate, allylcapronate, amarocit (1,1-dimethoxy-2,2,5-trimethyl-4-hexene), ambral (dodecahydro-3,8,8,11a-tetramethyl-5h-3.5a-epoxynaphth[2.1-c]oxepine), ambrettolide (9-hexadecene-16-olide), ambrinol S (1,2,3,4,4a,5,6,7-octahydro-2,6,6-trimethyl-2-napthalinol), ambrinolepoxide, ambrocenide (4ar,5r,7as,9r)-octahydro-2,2,5,8,8,9a-hexamethyl-4h-4a,9-methanoazuleno(5,6-d)-1,3-dioxole), ambroxide (3a,6,6,9a-tetramethyl-dodecahydronaphtho[2,1-b]-furan), amylformiate, aurelione (7-cyclohexadecene-1-on und 8-cyclohexadecene-1-on), boronal [2-methyl-4-(2,6,6-trimethyl-1-cyclohexene-1-yl)-butenal], brahmanol [2-methyl-4-(2,2,3-trimethyl-3-cyclopentenyl)-butanol], buccoxime (1,5-dimethylbicyclo[3.2.1]octan-8-onoxim), butylacetate, cantryl (2,2,3-trimethyl-3-cyclopentenyl-1-acetonitrile), cassix 150 (4-methoxy-2-methyl-2-butanthiol), chrysantheme [1-(2,4-dimethyl-3-cyclohexene-1-yl)-2,2-dimethyl-1-propanone], cis-3-hexenylacetate, citronellylbutyrate, citronellyltiglinate (3,7-dimethyl-6-octenyl-2-methylcrotonate), citronitrile (3-methyl-5-phenyl-2-pentennitrile), citrowanil b (alpha-ethenyl-alpha-methyl benzene-proprannitrile), claritone (2,4,7-tetramethyl-6-octene-3-on), corps racine vs [2-(3-phenylpropyl)pyridinr], coumarone (1-(2-benzofuranyl)-ethanon), cyclogalbanate (allylcyclohexyloxyacetate), cyclohexylmagnol (alpha-methylcyclohexanpropanol), datilate (1-cyclohexylethylcrotonate), ethyl-2-methylbutyrate, ethylisobutyrate, ethylisovalerate, ethyltricyclo[5.2.1,02,6]decan-2-ylcarboxylate, farenal (2,6,10-trimethyl-9-undecenal), filbertone (5-methyl-2-heptene-4-on), fleursandol (4-(3a,4,5,6,7,7a-hexahydro-4,7-methano-1h-inden-6-yl)-3-methyl-3-butene-2-ol), florazon (4-ethyl-alpha,alpha-dimethyl benzenepropanal), floropal (2,4,6-trimethyl-4-phenyl-1,3-dioxane), fragolane [(2,4-dimethyl-[1,3]dioxolane-2-yl)acetic acid ethylester)], frutinat (but-2-en acid-1,3-dimethylbutyl ester), gamma-decalactone, geranylacetate, geranylbutyrate, geranyltiglinate (trans-3,7-dimethyl-2,6-octadienyl-2-methylcrotonate), globalide [(11/12)-pentadecen-15-olide], globanone (8-cyclo-hexadecene-1-on), hexylbutyrate, hydrocitronitrile (beta-methyl-benzenepentannitrile), indianol (4-[3a,4,5,6,7,7a-hexahydro-4,7-methano-1h-inden-5(6)-yl]-3-methyl-3-butene-2-ol), indoflor (4,4a,5,9b-tetrahydoindeno[1,2-d]-m-dioxin), irisnitrile (2-nonenylnitrile), isoamylacetate, isoamylisovalerianate, isodamascon [1-(2,4,4-trimethyl-2-cyclohexene-1-yl)-2-butene-1-on], isomuscon (cyclohexadecanon), jacinthaflor (2-methyl-4-phenyl-1,3-dioxolan), ketamber (dodecahydro-3,8,8,11a-tetramethyl-5h-3,5a-epoxynaphth[2.1-c]oxepine), lactojasmon (4-hexyl-4-methylbutyrolactone), leguminal (propanal-methyl-cis-3-hexenyl-acetal), macrolide (oxacyclohexadecan-2-on), madranol (mixture of different hexahydro methylionone), magnolan (2,4-dimethyl-5,6-indeno-1,3-dioxan), majantol [2,2-dimethyl-3-(3-methylphenyl)-propanol], mandaril (3,12-tridecadiennitrile), menthylacetate, methylbutyrate, methyldihydrojasmonate, methylisobutyrate, mintonat (3,3,5-trimethylcyclohexylacetate), mugetanol [1-(4-isopropylcyclohexyl)-ethanol], nerolione [1-(3-methyl-2-benzofuranyl)-ethanon], octylacetate, ozonile (2-tridecennitrile), palisandal (1,1-dimethoxycyclododecan), palisandin (cyclododecylmethyl ether), parmanyl [3-(cis-3-hexenyloxy)-propannitrile], passifloran (3-acetylthiohexylacetate), peacholide (cis- und trans-3-methyl-gamma-decalacton), prenylsalicylat, profarnesal (2,6,10-trimethyl-5,9-undecadienal), projasmon p (2-heptylcyclopentanon), pyroprunate (but-2-en acid bicyclopenten-2-yl-ester), rholiate (carbonic acid-ethyl-2,3,6-trimethylcyclohexylester), rosaphen (2-methyl-5-phenylpentan-1-ol), rosenoxid, sandel 80 (trans-3-isocamphylcyclohexanol), sandranol (2-ethyl-4-(2,2,3-trimethyl-3-cyclpentene-1-yl)-2-buten-1-ol), symrose (4-isoamylcyclohexanol), symroxane (4-(3-methylbutyl)-cyclohexanol (z)), tabanon [4-(2-butenyliden)-3,4,5-trimethyl-2-cyclohexene-1-on], terpineol-4, timberol (2,2,6-trimethyl-alpha-propyl-cyclohexanpropanol), tolylacetataldeyde d para (4-methyl-benzeneacetaldehyde), tricyclodecenylpropionate, tropicol (2-mercapto-2-methyl-pentan-1-ol), vertosine [2-(2,4-(or 3,5)-dimethyl-3-cyclohexene-1-yl)-methylenaminobenzoic acidmethyl-ester], vertral (octahydro-4,7-methano-1h-indencarbaldehyde), vetikolacetate (1,3-dimethyl-3-phenylbutylacetate), vetival (4-cyclohexyl-4-methylpentan-2-on), ysamber k (spiro hexahydro-1′,1′,5′,5′-tetramethyl-[1,3-dioxolan-2,8′-(5′h)-[2h-2, 4a]-methanonaphthalene], and/or
such listed in S. Arctander, Perfume and Flavor Materials, Vol. I and II, Montclair, N. J. 1969, self-publishing, or K. Bauer et al., Common Fragrance and Flavor Materials, 5th Edition, Wiley-VCH, Weinheim 2006, and/or
extracts of natural raw materials, e.g. essential oils, concretes, absolues, resine, resinoides, balms, tinctures, such as e.g. ambratincture; amyris oil; angelicaseed oil; angelicaroot oil; anise oil; valerian oil; basil oil; tree moss-absolue; bay oil; mugwort oil; benzoic resin; bergamot oil; beeswax-absolue; birch tar oil; bitter almond oil; savoury oil; bucco leaf oil; cabreuva oil; cade oil; calmus oil; campher oil; cananga oil; cardamomen oil; cascarilla oil; cassia oil; cassie-absolue; castoreum-absolue; cedar leaf oil; cedar wood oil; cistus oil; citronella oil; lemon oil; copaivabalm; copaivabalm oil; coriander oil; costus root oil; cumin oil; cypressoil; davana oil; dill herb oil; dill seed oil; eau de brouts-absolue; oakmoss-absolue; elemi oil; estragon oil; eucalyptus-citriodora-oil; eucalyptus oil; fennel oil; spruce needle oil; galbanum oil; galbanumresin; geranium oil; grapefruit oil; guajak wood oil; gurjunbalm; gurjunbalm oil; helichrysum-absolue; helichrysum oil; ginger oil; iris root-absolue; iris root oil; jasmin-absolue; kalmus oil; chamomile oil blue; chamomile oil roman; carrot seed oil; kaskarilla oil; pine needle oil; spearmint oil; caraway oil; labdanum oil; labdanum-absolue; labdanumresin; lavandin-absolue; lavandin oil; lavender-absolue; lavender oil; lemongras oil; lovage oil; lime oil destilled; limette oil pressed; linaloe oil; litsea-cubeba-oil; bay leaf oil; macis oil; majoram oil; mandarin oil; massoirinden oil; mimosa-absolue; musk grain oil; musk tincture; muscatel-sage oil; nutmeg oil; myrrh-absolue; myrrh oil; myrtlen oil; carnation leaf oil; carnation blossom oil; neroli oil; olibanum-absolue; olibanum oil; opopanax oil; orange blossom-absolue; orange oil; origanum oil; palmarosa oil; patchouli oil; perilla oil; perubalm oil; parsley leaf oil; parsley seed oil; petitgrain oil; pepermint oil; pepper oil; piment oil; pine oil; poley oil; rose-absolue; rosewood oil; rose oil; rosemary oil; sage oil dalmatian; sage oil spanish; sandalwood oil; celery seed oil; spike lavender oil; star anise oil; styrax oil; marigold oil; fir needle oil; tea tree oil; turpentine oil; thyme oil; tolubalm; tonka-absolue; tuberose absolue; vanilla extract; violet leaf absolue; verbena oil; vetiver oil; juniper oil; wine yeast oil; vermouth oil; wintergreen oil; ylang oil; ysop oil; zibet-absolue; cinnamon leaf oil; cinnamon bark oil as well as fractions thereof or ingredients isolated thereof, and/or
single aromatic substances of the group of carbohydrates, e.g. 3-carene; alpha-pinene; beta-pinene; alpha-terpinene; gamma-terpinene; p-cymol; bisabolene; camphene; caryophyllene; cedrene; farnesene; limonene; longifolene; myrcene; ocimene; valencene; (e,z)-1,3,5-undecatriene; styrole; diphenylmethan; aliphatic alcohols such as e.g. hexanol; octanol; 3-octanol; 2,6-dimethylheptanol; 2-methyl-2-heptanol; 2-methyl-2-octanol; (e)-2-hexenol; (e)-und (z)-3-hexenol; 1-octen-3-ol; mixture of 3,4,5,6,6-pentamethyl-3/4-hepten-2-ol und 3,5,6,6-tetramethyl-4-methyleneheptan-2-ol; (e,z)-2,6-nonadienol; 3,7-dimethyl-7-methoxyoctan-2-ol; 9-decenol; 10-undecenol; 4-methyl-3-decen-5-ol; aliphatic aldehydes and their acetates as e.g. hexanal; heptanal; octanal; nonanal; decanal; undecanal; dodecanal; tridecanal; 2-methyloctanal; 2-methylnonanal; (e)-2-hexenal; (z)-4-heptenal; 2;6-dimethyl-5-heptenal; 10-undecenal; (e)-4-decenal; 2-dodecenal; 2,6,10-trimethyl-9-undecenal; 2,6,10-trimethyl-5,9-undecadienal; heptanaldiethylacetal; 1,1-dimethoxy-2,2,5-trimethyl-4-hexene; citronellyloxyacetaldehyde; 1-(1-methoxy-propoxy)-(e/z)-3-hexene; aliphatic ketones and their oximes such as e.g. 2-heptanon; 2-octanon; 3-octanon; 2-nonanon; 5-methyl-3-heptanon; 5-methyl-3-heptanonoxime; 2,4,4,7-tetramethyl-6-octene-3-on; 6-methyl-5-heptene-2-on; aliphatic sulphurous compounds such as e.g. 3-methylthio-hexanol; 3-methylthiohexylacetate; 3-mercaptohexanol; 3-mercaptohexylacetate; 3-mercaptohexylbutyrate; 3-acetylthiohexylacetate; 1-menthen-8-thiol; aliphatic nitriles such as e.g. 2-nonene acid nitrile; 2-undecene acid nitrile; 2-tridecene acid nitrile; 3,12-tridecadiene acid nitrile; 3,7-dimethyl-2,6-octadiene acid nitrile; 3,7-dimethyl-6-octene acid nitrile; esters of aliphatic carboxylic acids such as e.g. (e)-und (z)-3-hexenylformiate; ethylacetoacetate; isoamylacetate; hexylacetate; 3,5,5-trimethylhexylacetate; 3-methyl-2-butenylacetate; (e)-2-hexenylacetate; (e)- and (z)-3-hexenylacetate; octylacetate; 3-octylacetate; 1-octen-3-ylacetate; ethylbutyrate; butylbutyrate; isoamylbutyrate; hexylbutyrate; (e)- and (z)-3-hexenyl-isobutyrate; hexylcrotonate; ethylisovalerianate; ethyl-2-methylpentanoate; ethylhexanoate; allylhexanoate; ethylheptanoate; allylheptanoate; ethyloctanoate; ethyl-(e,z)-2,4-decadienoate; methyl-2-octinate; methyl-2-noninate; allyl-2-isoamyloxyacetate; methyl-3,7-dimethyl-2,6-octadienoate; 4-methyl-2-pentylcrotonate; acyclic terpene alcohols such as e.g. citronellol; geraniol; nerol; linalool; lavadulol; nerolidol; farnesol; tetrahydrolinalool; tetrahydrogeraniol; 2,6-dimethyl-7-octene-2-ol; 2,6-dimethyloctane-2-ol; 2-methyl-6-methylene-7-octene-2-ol; 2,6-dimethyl-5,7-octadiene-2-ol; 2,6-dimethyl-3,5-octadiene-2-ol; 3,7-dimethyl-4,6-octadiene-3-ol; 3,7-dimethyl-1,5,7-octatriene-3-ol 2,6-dimethyl-2,5,7-octatriene-1-ol; as well as their formiates, acetates, propionates, isobutyrates, butyrates, isovalerianates, pentanoates, hexanoates, crotonates, tiglinates and 3-methyl-2-butenoates; acyclic terpene aldehydes and ketones such as e.g. geranial; neral; citronellal; 7-hydroxy-3,7-dimethyloctanal; 7-methoxy-3,7-dimethyloctanal; 2,6,10-trimethyl-9-undecenal; geranylaceton; as well as the dimethyl and diethylacetals of geranial, neral, 7-hydroxy-3,7-dimethyloctanal; cyclic terpene alcohols such as e.g. menthol; isopulegol; alpha-terpineol; terpinenol-4; menthan-8-ol; menthan-1-ol; menthan-7-ol; borneol; isoborneol; linalooloxid; nopol; cedrol; ambrinol; vetiverol; guajol; as well as their formiates, acetates, propionates, isobutyrates, butyrates, isovalerianates, pentanoates, hexanoates, crotonates, tiglinates and 3-methyl-2-butenoates; cyclic terpene aldehydes and ketones such as e.g. menthone; isomenthone; 8-mercaptomenthan-3-one; carvone; campher; fenchone; alpha-ionone; beta-ionone; alpha-n-methylionone; beta-n-methylionone; alpha-isomethylionone; beta-isomethylionone; alpha-irone; alpha-damascone; beta-damascone; beta-damascenone; delta-damascone; gamma-damascone; 1-(2,4,4-trimethyl-2-cyclohexene-1-yl)-2-buten-1-one; 1,3,4,6,7,8a-hexahydro-1,1,5,5-tetramethyl-2h-2,4a-methanonaphthalene-8(5h)-one; 2-methyl-4-(2,6,6-trimethyl-1-cyclohexene-1-yl)-2-butenal; nootkatone; dihydronootkatone; 4,6,8-megastigmatrien-3-one; alpha-sinensal; beta-sinensal; acetylated cedar wood oil (methylcedrylketone); cyclic alcohols such as e.g. 4-tert.-butylcyclohexanol; 3,3,5-trimethylcyclohexanol; 3-isocamphylcyclohexanol; 2,6,9-trimethyl-z2,z5,e9-cyclododecatriene-1-ol; 2-isobutyl-4-methyltetrahydro-2h-pyran-4-ol; cycloaliphatic alcohols such as e.g. alpha,3,3-trimethylcyclohexylmethanol; 1-(4-isopropylcyclohexyl)ethanol; 2-methyl-4-(2,2,3-trimethyl-3-cyclopent-1-yl) butanol; 2-methyl-4-(2,2,3-trimethyl-3-cyclopent-1-yl)-2-butene-1-ol; 2-ethyl-4-(2,2,3-trimethyl-3-cyclopent-1-yl)-2-butene-1-ol; 3-methyl-5-(2,2,3-trimethyl-3-cyclopent-1-yl)-pentan-2-ol; 3-methyl-5-(2,2,3-trimethyl-3-cyclopent-1-yl)-4-pentene-2-ol; 3,3-dimethyl-5-(2,2,3-trimethyl-3-cyclopent-1-yl)-4-pentene-2-ol; 1-(2,2,6-trimethyl-cyclohexyl)pentan-3-ol; 1-(2,2,6-trimethylcyclohexyl)hexan-3-ol; cyclic and cycloaliphatic ether such as e.g. cineol; cedrylmethyl ether; cyclododecylmethyl ether; 1,1-dimethoxycyclododecan; (ethoxymethoxy)cyclododecan; alpha-cedrenepoxid; 3a,6,6,9a-tetramethyldodecahydronaphtho[2,1-b]furan; 3a-ethyl-6,6,9a-trimethyldodecahydronaphtho[2,1-b]furan; 1,5,9-trimethyl-13-oxabicyclo[10.1,0]trideca-4,8-diene; rose oxide; 2-(2,4-dimethyl-3-cyclohexene-1-yl)-5-methyl-5-(1-methylpropyl)-1,3-dioxane; cyclic and macrocyclic ketones such as e.g. 4-tert.-butylcyclohexanone; 2,2,5-trimethyl-5-pentylcyclopentanone; 2-heptylcyclopentanone; 2-pentylcyclopentanone; 2-hydroxy-3-methyl-2-cyclopentene-1-one; 3-methyl-cis-2-pentene-1-yl-2-cyclopentene-1-one; 3-methyl-2-pentyl-2-cyclopentene-1-one; 3-methyl-4-cyclopentadecenone; 3-methyl-5-cyclo-pentadecenone; 3-methylcyclopentadecanone; 4-(1-ethoxyvinyl)-3,3,5,5-tetramethylcyclohexanone; 4-tert-pentylcyclohexanone; 5-cyclohexadecene-1-one; 6,7-dihydro-1,1,2,3,3-pentamethyl-4(5h)-indanone; 8-cyclohexadecene-1-one; 9-cycloheptadecene-1-one; cyclopentadecanone; cyclohexadecanone; cycloaliphatic aldehydes such as e.g. 2,4-dimethyl-3-cyclohexencarbaldehyde; 2-methyl-4-(2,2,6-trimethyl-cyclohexene-1-yl)-2-butenal; 4-(4-hydroxy-4-methylpentyl)-3-cyclohexencarbaldehyde; 4-(4-methyl-3-pentene-1-yl)-3-cyclohexencarbaldehyde; cycloaliphatic ketones such as e.g. 1-(3,3-dimethylcyclohexyl)-4-pentene-1-one; 2,2-dimethyl-1-(2,4-dimethyl-3-cyclohexene-1-yl)-1-propanone; 1-(5,5-dimethyl-1-cyclohexene-1-yl)-4-pentene-1-one; 2,3,8,8-tetramethyl-1,2,3,4,5,6,7,8-octahydro-2-naphtalenylmethylketone; methyl-2,6,10-trimethyl-2,5,9-cyclododecatrienylketone; tert.-butyl-(2,4-dimethyl-3-cyclohexen-1-yl)ketone; esters of cyclic alcohols such as e.g. 2-tert-butylcyclohexylacetate; 4-tert-butylcyclohexylacetate; 2-tert pentylcyclohexylacetate; 4-tert-pentylcyclohexylacetate; 3,3,5-trimethylcyclohexylacetate; decahydro-2-naphthylacetate; 2-cyclopentylcyclopentylcrotonate; 3-pentyltetrahydro-2h-pyran-4-ylacetate; decahydro-2,5,5,8a-tetramethyl-2-naphthylacetate; 4,7-methano-3a,4,5,6,7,7a-hexahydro-5, or 6-indenylacetate; 4,7-methano-3a,4,5,6,7,7a-hexahydro-5, or 6-indenylpropionate; 4,7-methano-3a,4,5,6,7,7a-hexahydro-5, or 6-indenylisobutyrate; 4,7-methanooctahydro-5, or 6-indenylacetate; esters of cycloaliphatic alcohols such as e.g. 1-cyclohexylethylcrotonate; esters of cycloaliphatic carboxylic acids such as e.g. allyl-3-cyclohexylpropionate; allylcyclohexyloxyacetate; cis- and trans-methyldihydrojasmonate; cis- and trans-methyljasmonate; methyl-2-hexyl-3-oxocyclopentancarboxylate; ethyl-2-ethyl-6,6-dimethyl-2-cyclohexencarboxylate; ethyl-2,3,6,6-tetramethyl-2-cyclohexencarboxylate; ethyl-2-methyl-1,3-dioxolan-2-acetate; araliphatic alcohols such as benzene alcohol; 1-phenylethylalkohol; 2-phenylethylalkohol; 3-phenylpropanol; 2-phenylpropanol; 2-phenoxyethanol; 2,2-dimethyl-3-phenylpropanol; 2,2-dimethyl-3-(3-methylphenyl)propanol; 1,1-dimethyl-2-phenylethylalkohol; 1,1-dimethyl-3-phenylpropanol; 1-ethyl-1-methyl-3-phenylpropanol; 2-methyl-5-phenylpentanol; 3-methyl-5-phenylpentanol; 3-phenyl-2-propen-1-ol; 4-methoxybenzene alcohol; 1-(4-isopropylphenyl)ethanol; esters of araliphatic alcohols and araliphatic carboxylic acids such as e.g. benzylacetate; benzylpropionate; benzylisobutyrate; benzylisovalerianate; 2-phenylethylacetate; 2-phenylethylpropionate; 2-phenylethylisobutyrate; 2-phenylethylisovalerianate; 1-phenylethylacetate; alpha-trichlormethylbenzylacetate; alpha,alpha-dimethylphenylethylacetate; alpha,alpha-dimethylphenylethylbutyrate; cinnamylacetate; 2-phenoxyethylisobutyrate; 4-methoxybenzylacetate; araliphatic ethers such as e.g. 2-phenylethylmethyl ether; 2-phenylethylisoamyl ether; 2-phenylethyl-1-ethoxyethyl ether, phenylacetaldehyddimethylacetale; phenylacetaldehyddiethylacetale; hydratropaaldehyddimethylacetale; phenylacetaldehydglycerinacetale; 2,4,6-trimethyl-4-phenyl-1,3-dioxan; 4,4a,5,9b-tetrahydroindeno[1,2-d]-m-dioxin; 4,4a,5,9b-tetrahydro-2,4-dimethylindeno[1,2-d]-m-dioxin; aromatic and araliphatic aldehydes such as e.g. benzaldehyde; phenylacetaldehyde; 3-phenylpropanal; hydratropaaldehyde; 4-methylbenzaldehyde; 4-methylphenylacetaldehyde; 3-(4-ethylphenyl)-2,2-dimethylpropanal; 2-methyl-3-(4-isopropylphenyl)propanal; 2-methyl-3-(4-tert.-butylphenyl)propanal; 2-methyl-3-(4-isobutylphenyl)propanal; 3-(4-tert.-butylphenyl)propanal; cinnamic aldehyde; alpha-butylzimtaldehyde; alpha-amylzimtaldehyde; alpha-hexylzimtaldehyde; 3-methyl-5-phenylpentanal; 4-methoxybenzaldehyde; 4-hydroxy-3-methoxybenzaldehyde; 4-hydroxy-3-ethoxybenzaldehyde; 3,4-methylendioxybenzaldehyde; 3,4-dimethoxybenzaldehyde; 2-methyl-3-(4-methoxyphenyl)propanal; 2-methyl-3-(4-methylendioxyphenyl)propanal; aromatic and araliphatic ketones such as e.g. acetophenone; 4-methylacetophenone; 4-methoxyacetophenone; 4-tert.-butyl-2,6-dimethylacetophenone; 4-phenyl-2-butanone; 4-(4-hydroxyphenyl)-2-butanone; 1-(2-naphthalenyl)ethanone; 2-benzofuranylethanone; (3-methyl-2-benzofuranyl)ethanone; benzophenone; 1,1,2,3,3,6-hexamethyl-5-indanylmethylketone; 6-tert.-butyl-1, 1-dimethyl-4-indanylmethylketone; 1-[2,3-dihydro-1,1,2,6-tetramethyl-3-(1-methylethyl)-1h-5-indenyl]ethanone; 5′,6′,7′,8′-tetrahydro-3′,5′,5′,6′,8′,8′-hexamethyl-2-acetonaphthone; aromatic and araliphatic carboxylic acids and their esters such as e.g. benzoic acid; phenylacetic acid; methylbenzoate; ethylbenzoate; hexylbenzoate; benzyl-benzoate; methylphenylacetate; ethylphenylacetate; geranylphenylacetate; phenylethyl-phenylacetate; methylcinnmate; ethylcinnamate; benzylcinnamate; phenylethylcinnamate; cinnamylcinnamate; allylphenoxyacetate; methylsalicylate; isoamylsalicylate; hexylsalicylate; cyclohexylsalicylate; cis-3-hexenylsalicylate; benzylsalicylate; phenylethylsalicylate; methyl-2,4-dihydroxy-3,6-dimethylbenzoate; ethyl-3-phenylglycidate; ethyl-3-methyl-3-phenylglycidate; nitrogenous aromatic compounds such as 2,4,6-trinitro-1,3-dimethyl-5-tert.-butylbenzol; 3,5-dinitro-2,6-dimethyl-4-tert-butylacetophenone; cinnamic acid nitrile; 3-methyl-5-phenyl-2-pentensaurenitrile; 3-methyl-5-phenylpentansaurenitrile; methylanthranilate; methy-n-methylanthranilate; schiff bases of methylantranilate with 7-hydroxy-3,7-dimethyloctanal, 2-methyl-3-(4-tert.-butylphenyl)propanal or 2,4-dimethyl-3-cyclohexencarbaldehyde; 6-isopropylchinoline; 6-isobutylchinoline; 6-sec.-butylchinoline; 2-(3-phenylpropyl)pyridine; indol; skatol; 2-methoxy-3-isopropylpyrazine; 2-isobutyl-3-methoxypyrazine; phenols, phenyl ethers and phenyl esters such as e.g. estragol; anethol; eugenol; eugenylmethyl ether; isoeugenol; isoeugenylmethyl ether; thymol; carvacrol; diphenyl ether; beta-naphthylmethyl ether; beta-naphthylethyl ether; beta-naphthylisobutyl ether; 1,4-dimethoxybenzol; eugenylacetate; 2-methoxy-4-methylphenol; 2-ethoxy-5-(1-propenyl)phenol; p-kresylphenylacetate; heterocyclic compounds such as e.g. 2,5-dimethyl-4-hydroxy-2h-furan-3-one; 2-ethyl-4-hydroxy-5-methyl-2h-furan-3-one; 3-hydroxy-2-methyl-4h-pyran-4-one; 2-ethyl-3-hydroxy-4h-pyran-4-one; lactones such as e.g. 1,4-octanolide; 3-methyl-1,4-octanolide; 1,4-nonanolide; 1,4-decanolide; 8-decen-1,4-olide; 1,4-undecanolide; 1,4-dodecanolide; 1,5-decanolide; 1,5-dodecanolide; 4-methyl-1,4-decanolide; 1,15-pentadecanolide; cis- and trans-11-pentadecene-1, 15-olide; cis- and trans-12-pentadecene-1, 15-olide; 1,16-hexadecanolide; 9-hexadecene-1,16-olide; 10-oxa-1,16-hexadecanolide; 11-oxa-1, 16-hexadecanolide; 12-oxa-1, 16-hexadecanolide; ethylen-1,12-dodecandioate; ethylen-1,13-tridecandioate; coumarin; 2,3-dihydrocoumarin; and octahydrocoumarin.

In case the, one, two, three or more or all of the first active substance(s) a3) and/or the, one, two, three or more or all of the second active substance(s) b3) contain(s) (a) fragrance(s), such fragrances are typically released from the formed water-soluble film, preferably hydrogel, by diffusion.

It is also conceivable to adsorb the fragrance(s), particularly perfume oils, to a carrier, which ensures a fine distribution of the therein included fragrances in the product as well as a controlled release when used. Such carriers can be porous inorganic materials such as light grade sodium sulfate, silica gel, zeolites, gypsum, clays, aerosil, clay granulates, aerated concrete or gas concrete etc. Or organic materials such as woods, cellulose based substances sugar, dextrines (e.g. maltodextrin) or synthetic materials such as PVC, polyvinyl acetates or poly urethanes. It will be appreciated that this carriers perferably exhibit small dimensions, such that they are not (optically) disturbing the customer. For instance, a carrier may have any shape and less than 1 mm in each spatial direction, such as less than 0.5 mm, or less than 0.1 mm. adsorbing the fragrance(s) to a carrier has the advantage of longer lifetime of the fragrance(s) before their actual use, i.e. release to the environment.

Additionally, or alternatively, the, one, two, three or more or all of the first active substance(s) a3) and/or the, one, two, three or more or all of the second active substance(s) b3) is/are dyes and/or their lacquers. These are preferably food colorants, as they necessarily need to be toxicologically and dermatologically harmless. The approved food colorants include E 129 to E 161: allura red AC E 129 rot; aluminium E 173; amaranth E 123 rot; anthocyane E 163 violet, blue; Azorubine E 122 red; betanine E 162 red; brown FK E 154 yellowish brown; brown HT E 155 red brown; brilliant blue FCF E 133 blue; brilliant black BN E 151 violet, brown, black; calciumcarbonate E 170; canthaxanthine E 161 g; carotin; * annatto (norbixin); * capsanthine; * lycopine; * 8′-apo-βcaroten-8′-a1; * ethyl-8′-apo-&bgr;-caroten-8′-oate E 160 a; E 160 b; E 160 c; E 160 d; E 160 e; E 160 f; chinoline yellow E 104; chlorophyll E 140 green; cochenile ret A E 124; curcumin E 100; iron oxide E 172; erythrosine E 127; yellow-orange S E 110; gold E 175; green S E 142; indigotine E 132; cochineal E 120; copper containing complexes of chlorophylls and chlorophyllines E 141; lactoflavin E 101; litholrubine BK E 180; lutein E 161 b; patent blue V E 131; vegetable carbon E 153; riboflavine (vitamin B2); * riboflavine-5-phosphate E 101; E 101 a; Safflower cherry red to brown-yellow; silver E 174; tartrazine E 102; titanium dioxide E 171; caramel colour; * Sulphite lye-caramel colour; * Ammoniac-caramel colour; *Ammon sulphite-caramel colour E 150 a; E 150 b; E 150 c; E 150 d; und Zeaxanthine E 161 h. Suitable dyes can additionally be found in DE 202013006887, the contents of which are incorporated by way of reference.

The use of one or more dyes has the effect that the present two component composition has a desired colour. The colour may serve as an indicator for the thickness of the film upon applying the present two component composition on a surface. The customer may therefore at least approximately (such as plus/minus one day, or plus/minus two days) adjust the lifetime of active constituent effect, such as fragrance effect, by depositing films of controlled thickness on a surface. For this purpose, the present two component composition may be provided in form of a kit, the kit including instructions and/or a colour table permitting (at least approximate) attribution of the colour intensity of the film to the lifetime of active constituent effect, in particular the fragrance effect.

Preferably, the present two component composition does not include any dye or only in such amounts that it is difficult or impossible to perceive by the customer when applied to a surface.

The, one, two, three or more or all of the first active substance(s) a3) and/or the, one, two, three or more or all of the second active substance(s) b3), as well as their respective amounts, may correspond to the constituents of conventional cleaning agents for toilet bowls. Exemplary compositions may be derived from EP 0 538 957 and EP 0 785 315, U.S. Pat. Nos. 3,946,448, 6,178,564 and 6,230,334, WO 99/66139 and WO 99/66140, the contents of which are incorporated by way of reference.

Preferably, the, one, two, three or more or all of the first active substance(s) a3) and/or the, one, two, three or more or all of the second active substance(s) b3) is/are encapsulated. The capsules for encapsulating the active susbtance(s) may be any type of capsules, such as gelatin, starch or agar capsules, or matrix particles. Their preparation is well known in the art.

It is also conceivable to adsorb fragrance(s), i.e. a selection of such active substance(s), particularly perfume oils, to a carrier, which ensures a fine distribution of the therein included fragrances in the product as well as a controlled release when used. Such carriers can be porous inorganic materials such as light grade sodium sulfate, silica gel, zeolites, gypsum, clays, aerosil, clay granulates, aerated concrete or gas concrete etc. or organic materials such as woods, cellulose based substances sugar, dextrines (e.g. maltodextrin) or synthetic materials such as PVC, polyvinyl acetates or poly urethanes. It will be appreciated that this carriers preferably exhibit small dimensions, such that they are not (optically) disturbing the customer. For instance, a carrier may have any shape and less than 1 mm in each spatial direction, such as less than 0.5 mm, or less than 0.1 mm. adsorbing the fragrance(s) to a carrier has the advantage of longer lifetime of the fragrance(s) before their actual use, i.e. release to the environment.

To facilitate the disintegration of the of the present two component composition, it is possible to alternatively or additionally incorporate disintegration tools, so called disintegrants, in these materials to shorten the disintegration times. Disintegrants or disintegration accelerators are generally understood as tools providing a rapid disintegration, especially of tablets, in water or other media and rapid release of the active ingredients. These substances, also being called “exploders” due to their effect, increase their volume when water is added, wherein on the one hand the tare volume is increased (swelling) and on the other hand further pressure is obtained by the release of gases, which disintegrates the tablet into smaller particles. Known disintegration tools are for example carbonate/citric acid systems, wherein also other organic acids can be used. Swelling disintegration tools are for example synthetic polymers such as polyvinylpyrrolidone (PVP) or natural polymers or modified natural materials such as cellulose and starch and its derivatives, alginates or casein derivatives.

Disintegrants based on cellulose or starches are used as preferred disintegrants. Pure cellulose shares the formal gross composition (C6H10O5)n and formally represents a beta-1,4-polyacetate of cellobiose, which in turn is build up of two molecules of glucose. Suitable celluloses thereby consist of approximately 500 to 5,000 glucose units and thus have average molar masses of 50,000 to 500,000. Cellulose derivatives, which are obtainable by polymeric analogous reactions of cellulose, can also be used as disintegration tools based on cellulose according to the present invention. Such chemical modified celluloses thereby comprise for example products of esterifications or etherifications, in which hydroxyl groups were substituted by hydrogen atoms. But also celluloses, in which the hydroxyl groups were substituted with functional groups, not bound via an oxygen atom, can be used as cellulose derivatives. The group of cellulose derivatives includes for example alkali celluloses, carboxymethyl cellulose (CMC), cellulose esters and ethers as well as amino celluloses.

The listed cellulose derivatives are preferably used as disintegration tools, which are not solely based on cellulose, but in a mixture with cellulose. The content of cellulose derivatives of these mixtures is preferably below 50 wt.-%, particularly preferably below 20 wt.-% with regard to the disintegration tool based on cellulose. Pure cellulose, free of cellulose derivatives, is particularly preferably used as disintegration tool based on cellulose.

The cellulose being used as disintegrant is preferably not used as fine-particled form, but is converted into a gross form before being added to the premixes to be pressed, for example by granulation or compacting.

As further disintegrant based on cellulose or as part of this component, microcrystalline cellulose can be used. This microcrystalline cellulose is obtained by partial hydrolysis of celluloses under such conditions that only attack and completely dissolve the amorphous parts (approx. 30% of the total amount of cellulose) of the celluloses, whereas the crystalline parts (approx. 70%) remain intact. A following disaggregation of the micro-fine celluloses obtained by the hydrolysis provides the microcrystalline celluloses showing primary particle sizes of approx. 5 μm and being compactable to for example granulates with an average particle size of 200 μm.

Preferred antimicrobial compounds which can be used in the present two component composition are benzoic acid, its esters and salts, propionic acid and its salts, salicylic acid and its salts, 2,4-hexadiene acid (sorbic acid) and its salts, formaldehyde and paraformal-dehyde, 2-hydroxybiphenylether und seine salze, 2-zinksulfidopyridin-n-oxid, anorgani-sche sulfite und bisulfite, natriumiodat, chlorbutanolum, 4-ethylquecksilber-(ii)5-amino-1,3-bis(2-hydroxy benzoic acid, its salts and esters, dehydroacetic acid, formic acid, 1,6-bis(4-amidino-2-bromphenoxy)-n-hexan and its salts, the sodium salt of ethylmercury-(ii)-thiosalicylic acid, phenylmercury and its salts, 10-undecylenic acid and its salts, 5-amino-1,3-bis(2-ethylhexyl)-5-methylhexahydropyrimidine, 5-bromine-5-nitro-1,3-dioxane, 2-bromine-2-nitro-1,3-propandiol, 2,4-dichloro benzyl alcohol, n-(4-chlorophenyl)-n′-(3,4-dichlorophenyl)-urea, 4-chlor-m-kresol, 2,4,4′-trichlor-2′-hydroxy-diphenyl ether, 4-chlor-3,5-dimethylphenol, 1,1′-methylen-bis(3-(1-hydroxymethyl-2,4-dioximidazolidin-5-yl)urea), poly-(hexamethylenediguanide)-hydrochloride, 2-phenoxyethanol, hexamethylene tetramine, 1-(3-chloroallyl)-3,5,7-triaza-1-azonia-adamantane chloride, 1(4-chlorophenoxy)1(1h-imidazol-1-yl)-3,3-dimethyl-2-butanon, 1,3-bis-(hydroxy-methyl)-5,5-dimethyl-2,4-imidazolidindion, benzyl alcohol, octopirox, 1,2-dibromine-2,4-dicyanobutan, 2,2′-methylene-bis(6-bromine-4-chlorophenol), bromochlorophene, mixture of 5-chloro-2-methyl-3(2h)-isothiazolinon and 2-methyl-3(2h)isothiazlinon with magnesium chloride and magnesium nitrate, 2-benzyl-4-chlorophenol, 2-chloroacetamide, chlorhexidine, chlorhexidine acetate, chlorhexidine gluconate, chlorhexidine hydrochloride, 1-phenoxy-propan-2-ol, n-alkyl(c12-c22)trimethyl-ammoniumbromide and -chloride, 4,4-dimethyl-1,3-oxazolidine, n-hydroxymethyl-n-(1,3-di(hydroxymethyl)-2,5-dioxoimidazolidine-4-yl)-n′-hydroxy-methyl urea, 1,6-bis(4-amidino-phenoxy)-n-hexan and its salts, glutaraldehyde, 5-ethyl-1-aza-3,7-dioxabicyclo(3.3.0)octan, 3-(4-chlorphenoxy)-1,2-propanediol, hyamine, alkyl-(c8-c18)-dimethyl-benzyl-ammoniumchloride, alkyl-(c8-c18)-dimethyl-benzylammonium-bromide, alkyl-(c8-c18)-dimethyl-benzyl-ammoniumsaccharinate, benzylhemiformal, 3-iodine-2-propinyl-butylcarbamate, sodium-hydroxymethyl-aminoacetate or sodium-hydroxymethyl-aminoacetate. Further examples of suitable antimicrobials can be found in DE102011085798, the contents of which are incorporated by way of reference.

According to a particularly preferred embodiment of the present invention, a home care product is provided. The home care product comprises the two component composition according to the invention. What is said herein with regard to the two component composition according to the invention also applies to a two component composition comprised in the home care product as described herein, where applicable.

Examples of home care products comprise a (toilet) cleaning gel. Such a (toilet) cleaning gel preferably includes one or more fragrance(s) and one or more antimicrobial compounds.

Preferably, the home care product is adapted for contacting and depositing the first component and the second component on the surface.

The home care product may have a mixing device, such as a spraying device, in which the first component and the second component are contacted (and optionally mixed) and ejected, particularly sprayed, on a surface, such as an interior surface of a toilet. For this purpose, the home care product advantageously has two compartments, wherein a first compartment comprises the first component and a second compartment comprises the second component. It is conceivable to provide one or both compartments with a heating device. It is preferred that only the second compartment is provided with a heating device which functions by mixing required amounts of an acid and base, such as aqueous HCl and NaOH solutions, in the second compartment immediately before contacting the first component and the second component. The exothermic reaction taking place upon mixing acid and base may provide the required elevated temperature.

Preferably, the home care product thus further comprises a mixing device for contacting and depositing the first and second component on the surface.

Examples of suitable mixing devices encompass a conventional spray or applicator nozzle.

The mixing device may further provide contacting (and optionally mixing) of the first and second components before depositing on a surface, such as in the spray head/spray nozzle, or directly on the surface, such as by providing two spraying jets which contact each other on the surface.

Preferably, the steps of contacting the first component and the second component for obtaining a mixture and depositing the mixture on a surface, such as in the method according to the invention, occurs simultaneously or temporally consecutively.

The term “simultaneously” as used herein refers to the case, in which the first component and the second component encounter each other on the surface. This implies that two applicators, one for the first component and the other for the second component, are used. It is, however, preferred that the steps of contacting the first component and the second component for obtaining a mixture and depositing the mixture on a surface occurs temporally consecutively. In said case, mixing of the first and second component may take place in the applicator head, immediately, such as two seconds or less, or one second or less, before applying on the surface.

Preferably, the steps of contacting the first component and the second component for obtaining a mixture and/or depositing the mixture on a surface takes place at a temperature of 15° C. to 80° C., preferably 20° C. to 50° C.

The invention also relates to the use of the two component composition as described herein, or the home care product as described herein, as/in a home cleaning product, preferably for producing a (toilet) cleaning gel. What is said herein with regard to the two component composition according to the invention and/or with regard to the home care product according to the invention also applies to the use as described herein, where applicable.

The term “consist of” or “consisting of” describes, in the scope of the present invention, an exhaustive enumeration and excludes, apart from the explicitly mentioned components or steps, any further component or step.

The term “essentially consist of” or “essentially consisting of” describes, in the scope of the present invention, a partially exhaustive enumeration and describes compositions, which, in addition of the mentioned components, only include such further components, which do not substantively change the character of the composition or are present in amounts which do not substantively change the character of the composition.

Further features and advantages of the invention result from the subsequent description of preferred application examples.

### EXAMPLES

### Example 1: Selection of the Solvent for the Second Component

SLES was selected as second surfactant. Each sample was prepared on a 3 g scale, consisting of SLES (2 g) and solvent A-L according to the below table. Ethanol was evaluated as the most effective solvent to make clear, low viscosity solutions with high SLES concentration.

| [wt.- | | Solvent | | |
|---|---|---|---|---|
| %] | Solvent | concentration | Solubility | Viscosity |
| A | TPM | 33 | Yes | Very high |
| B | DOA | 33 | No | — |
| C | Propylene carbonate | 33 | No | — |
| D | IPM | 33 | No | — |
| E | BB | 33 | No | — |
| F | Neononyl acetate | 33 | No | — |
| G | Isopar L | 33 | No | — |
| H | DPM | 33 | Yes | Low |
| 1 | MMB | 33 | Yes | Low |
| J | Ethanol | 33 | Turbid | Low |
| K | Ethanol | 20 | Yes | Low |
| L | DMSO | 20 | No | — |

### Example 2: Concentration of the Solvent in the Second Component

To adjust the appropriate concentration of the solvent in the second component, different concentrations have been used as in the table below. The resulting mixture was then evaluated for its appearance, i.e. its spraying potential. The perfume oil was Violet Spa. Also, the perfume oils Nature Pine, Pink Bloom, Provence, Aquafresh and Lemon Explosions were used in the same concentration. The preferred concentration of the solvent was found to be 15.5 to 35 wt.-%.

| [wt.- | Hansanol | | | |
|---|---|---|---|---|
| %] | NS 242 | Ethanol | Perfume oil | Appearance |
| 1 | 80.0 | 10.0 | 10.0 | Gel |
| 2 | 72.7 | 18.2 | 9.1 | Liqid |
| 3 | 75.0 | 15.0 | 10.0 | Gel |
| 4 | 71.4 | 19.5 | 9.5 | Liquid |
| 5 | 73.0 | 17.0 | 10.0 | Liquid viscous |
| 6 | 72.0 | 18.0 | 10.0 | Liquid viscous |
| 7 | 70.0 | 20.0 | 10.0 | Liquid |

### Example 3: Viscosity of Different Compositions

| Ingredients | | |
|---|---|---|
| [wt.-%] | Component 1 | Component 2 |
| SLES | 16.0 | 56.0 |
| Lemon Explosion, | 5.0 | 0 |
| PJR10154AA | | |
| Ethanol | 0 | 20.0 |
| Water | 79 | 24 |

12 g portions of mixtures of component 1 and component 2 (as in the table above) were prepared in the speed mixer. Different mixing ratios of component 1 and component 2 were applied to achieve the below mixtures A to G.

| Ingredients [wt.-%] | A | B | C | D | E | F | G |
|---|---|---|---|---|---|---|---|
| SLES | 16.0 | 22.7 | 29.3 | 36.0 | 42.7 | 49.3 | 56.0 |
| Lemon Explosion, | 5.0 | 4.2 | 3.3 | 2.5 | 1.7 | 0.8 | 0 |
| PJR10154AA | | | | | | | |
| Ethanol | 0 | 3.3 | 6.7 | 10.0 | 13.3 | 16.7 | 20.0 |
| Water | 79 | 69.8 | 60.7 | 51.5 | 42.3 | 33.2 | 24 |

The stability of the resulting gels was evaluated by rheological measurements. The viscosity was constantly measured at \dot{y}=10 ms⁻¹, τ=6.4 Pa. The mixtures were mixed in a separate container and then applied onto the rheometer. After a short waiting time, the measurement was conducted. The rheometer was tempered to 25° C. The measured value was noted as soon as a constant value was obtained. The below values are averages of a triplicate measurement.

| Formulation | A | B | C | D | E | F | G |
|---|---|---|---|---|---|---|---|
| Viscosity [mPa*s] | 8.6 | 343.5 | 29500 | 26000 | 35000 | 194.3 | 54.1 |

### Example 4: Sprayable Formulations

| Ingredients [wt.-%] | H | I | J | K |
|---|---|---|---|---|
| SLES | 16 | 56 | 28 | 52.5 |
| Lemon Explosion, | 0 | 20 | 0 | 20 |
| PJR10154AA | | | | |
| Ethanol | 5 | 0 | 0 | 5 |
| Water | 79 | 24 | 72 | 22.5 |

The respective substances were provided and mixed in a speed mixer or a KPG agitator.

### Example 5: Adhesion Tests

First field experiments indicated that the major part of the formulation is lost with the first flush. Any residue left afterwards remains for a longer time period in the toilet. Consequently, the adhesion of the spray formulations was investigated in a funnel in order to quantify its residue after a first rinsing. Thereby, the combinations of different spray formula could be investigated and the most stable compositions could be determined.

A glass funnel (inlet: d=10 cm, h=8 cm; outlet: d=7 mm, l=10 cm) was filled with cold crane water (2×300 mL), emptied and allowed for one minute to drain. Prior to spray experiments, it was weighed. Then, the formulations H-K (Example 2) were filled into identical pump flasks and sprayed push by push vertically into the funnel with ratios according to the below table. The film was allowed to form over a period of 60 seconds, while its weight was monitored. Then, the funnel was purged with cold crane water (1×300 mL). Residual water was allowed to drop from the funnel for 60 seconds and the funnel was weighted immediately. All results have been measured as triplicates and are summarized below:

| | | | Relative | Composition [wt.-%] | | | |
|---|---|---|---|---|---|---|---|
| | Formulation, | Sprayed | loss | | | Perfume | |
| No. | ratio | mass | mass | SLES | Ethanol | oil | Water |
| 1 | H + I, 1:1 | 256.67 | 32.5 | 36.0 | 10.0 | 2.5 | 51.5 |
| 2 | H + I, 2:1 | 423.33 | 66.1 | 29.3 | 6.7 | 3.3 | 60.7 |
| 3 | H + I, 1:2 | 356.67 | 27.1 | 42.7 | 13.3 | 1.7 | 42.3 |
| 4 | H + K, 1:1 | 300.00 | 40.0 | 34.3 | 10.0 | 5.0 | 50.7 |
| 5 | H + K, 2:1 | 533.33 | 61.3 | 28.2 | 6.7 | 5.0 | 60.1 |
| 6 | H + K, 1:2 | 433.33 | 44.6 | 40.3 | 13.3 | 5.0 | 41.4 |
| 7 | J + K, 1:1 | 376.67 | 21.2 | 40.3 | 10.0 | 2.5 | 47.2 |
| 8 | J + K, 2:1 | 553.33 | 25.9 | 36.2 | 6.7 | 1.7 | 55.4 |
| 9 | J + K, 1:2 | 496.67 | 10.7 | 44.3 | 13.3 | 3.3 | 39.1 |
| 10 | J + K, 5:1 | 1120.00 | 59.5 | 32.1 | 3.3 | 0.8 | 63.8 |

The most stable formulations were no.s 9 (89.3% adhesion, 44.3% SLES, 13.3% EtOH, 3.3% perfume oil), 7 (78.8% adhesion, 40.3% SLES, 10.0% EtOH, 2.5% perfume oil), 8 (74.1% adhesion, 36.2% SLES, 6.7% EtOH, 1.7% perfume oil), 3 (72.9% adhesion, 42.7% SLES, 13.3% EtOH, 1.7% perfume oil) and 1 (67.5% adhesion, 36.0% SLES, 10.0% EtOH, 2.5% perfume oil).

### Example 6: Sensory Testing

In order to determine the most cost efficient perfume oil dosage, a gel was prepared and evaluated with varying perfume oil concentrations. The gels were prepared according to the below table. All samples were produced by mixing the components in containers standardized for all samples. All resulting gels had the same surface. A sensory evaluation was performed in rooms (2.5 m³) without ventilation. 18 non-professional panellists evaluated the rooms blindfolded in random order and rated the fragrance intensity.

| Sample | SLES | Ethanol | Perfume oil | Water |
|---|---|---|---|---|
| 1 | 38.50 | 10.00 | 5.00 | 46.50 |
| 2 | 38.50 | 10.00 | 3.75 | 47.75 |
| 3 | 38.50 | 10.00 | 2.50 | 49.00 |
| 4 | 38.50 | 10.00 | 1.25 | 50.25 |
| 5 | 38.50 | 10.00 | 0.00 | 51.50 |

Comparing the results and considering a cost-efficient approach. a perfume oil dosage of 2.5-5% has been adjudged to be most convenient:

The gel (24.00 g) was prepared in a 90 mL cup with a perfume oil concentration of 0.00%. 1.25%. 2.50%. 3.75% and 5.00%. The gel was covered with water (50 mL). After one minute. the water was decanted and disposed. while the cup was placed on a toilet tank in a closed cabin (2.5 m³). After 60 minutes. 18 non-professional panelists evaluated the cabins blindfolded in random order and rated the fragrance intensity on a scale of 0=below odour threshold to 9=very intensive. The blank feed could be distinguished highly significantly from all other samples. The difference between 1.25% and 5.00% perfume oil was very significant and the difference between 1.25% and 3.75%. as well as between 2.50% and 5.00% is rated as a tendency.

| Perfume oil | | | | | |
|---|---|---|---|---|---|
| concentration [wt.-%] | 0.00 | 1.25 | 2.50 | 3.75 | 5.00 |
| Intensity | 0.4 | 3.3 | 4.1 | 4.3 | 5.1 |

1-14. (canceled)

15. A two-component composition for depositing a water-soluble film on a surface comprising:
(a) a first component (a) comprising:
(a)(1) 0 to 30 wt. % of one or more surfactants, based on the total weight of the first component (a),
(a)(2) 60 to 100 wt. % of water, based on the total weight of the first component (a), and
(a)(3) 0 to 10 wt. % of one or more first active substances, based on the total weight of the first component (a); and
(b) a second component (b) comprising
(b)(1) 40 to 80 wt. % of one or more second surfactants, based on the total weight of the second component (b),
(b)(2) 0 to 40 wt. % of water, based on the total weight of the second component (b),
(b)(3) 0 to 10 wt. % of one or more second active substances, based on the total weight of the second component (b), and
(b)(4) 15.5 to 35 wt. % of one or more solvents, based on the total weight of the second component (b);
wherein contacting the first component (a) and the second component (b) causes formation of the water-soluble film.

16. The two-component composition of claim 15, wherein at least one of the one or more first surfactants of (a)(1) correspond to at least one of the one or more second surfactants of (b)(1).

17. The two-component composition of claim 15, wherein the one or more first surfactants of (a)(1) and/or the one or more second surfactants of (b)(1) are selected from acylamino acids, acyl peptides, sarcosinates, taurates, acyllactylates, alaninates, carboxylic acids and derivatives; ester carboxylic acids; ether carboxylic acids; phosphoric acid esters; sulphonic acids; alkylarylsulphonates, alkylsulphonates, sulphosuccinates, sulphuric acid esters, alkylsulphates, salts thereof, and combinations thereof.

18. The two-component composition of claim 15, wherein the one or more solvents of (b)(4) are selected from lower alcohols, tripropylene glycol methyl ether (TPM), dipropylene glycol methyl ether (DPM), 3-methoxy-3-methyl-1-butanol (MMB), dimethyl sulfoxide (DMSO), glycerine, triacetin, ethylene glycol, glycol, propanediol, augeo, trimethyleneglycol, methyl ethyleneglycol, ethyl ethylenglycol, methyl propylenglycol, ethyl aceto acetate, ethyl acetate, dipropylene glycol (DPG), dipropylene glycol methyl ether acetate (DPMA), cellulose acetate, acetonitrile (ACN), and combinations thereof.

19. The two-component composition of claim 15, wherein the one or more first active substances of (a)(3) and/or the one or more second active substances of (b)(3), if present, are selected from fragrances, co-solvents, preservatives, abrasives, anti-irritants, irritation suppressants, antioxidants, antiseptics, binders, buffers, chelating agents, deodorisers, disintegrants, emollients, fixatives, foaming agents, foam stabilisers, antifoams, foam boosters, fungicides, humectants, moisturisers, bleaching agents, stain removers, insect repellents, opacifiers, plasticisers, brighteners, abrasive agents, skin care agents, skin-protecting agents, skin-softening agents, skin-cooling agents, skin-warming agents, stabilisers, UV-absorbers, thickeners, vitamins, oils, waxes, fats, phospholipids, mono- and polyunsaturated fatty acids, α-hydroxy acids, polyhydroxy fatty acids, dyes, colour-protection agents, pigments, plant extracts, electrolytes, silicone derivatives, and combinations thereof.

20. The two-component composition of claim 15, wherein the first component (a) and the second component (b) together comprise a total of 25 to 50 wt. % of one or more surfactants, based on the total weight of the first component (a) and the second component (b) together.

21. The two-component composition of claim 15, wherein the first component (a) and the second component (b) are liquid and form a hydrogel when mixed with each other.

22. The two-component composition of claim 21, wherein the hydrogel formed when the first component (a) and the second component (b) are mixed with each other has a viscosity of at least 300 mPa*s.

23. A home care product comprising the two-component composition according to claim 15.

24. The home care product of claim 23, wherein the home care product is adapted for contacting and depositing the first component (a) and the second component (b) on a surface.

25. The home care product of claim 24 further comprising a mixing device that brings the first component (a) and the second component (b) into contact with each other on a surface.

26. The two-component composition of claim 21, wherein the hydrogel formed when the first component (a) and the second component (b) are mixed is a cleaning gel.

27. A method for depositing a water-soluble film on a surface comprising:
(i) providing the two-component composition of claim 15;
(ii) bringing the first component (a) and the second component (b) into contact with each other to obtain a mixture of the first component (a) and the second component (b),
wherein bringing the first component (a) and the second component (b) into contact with each other causes formation of the water-soluble film; and
(iii) depositing the mixture on the surface;
wherein (ii) and (iii) can be carried out simultaneously or consecutively.

28. A water-soluble film formed by the method of claim 27.

29. The two-component composition of claim 15, wherein the one or more solvents of (b)(4) are selected such that the one or more surfactants of (b)(1) and optionally the one or more surfactants of (a)(1) are soluble in the one or more solvent(s) of (b)(4).

30. The two-component composition of claim 15, wherein the one or more first active substances of (a)(3) and the one or more active substances of (b)(3) are fragrances.

31. The two-component composition of claim 15, wherein the first component (a) and the second component (b) together comprise a total of 30 to 65 wt. % of water, based on the total weight of the first component (a) and the second component (b) together.

32. The two-component composition of claim 15, wherein the first component (a) and the second component (b) together comprise a total of 7.5 to 15 wt. % of one or more solvents, based on the total weight of the first component (a) and the second component (b) together.

33. The two-component composition of claim 15, wherein the first component (a) and the second component (b) together comprise a total of 0 to 10 wt. % of one or more active substances, based on the total weight of the first component (a) and the second component (b) together.
